(19) United States
(12) Patent Application Publication
(10) Pub. No.: US 2016/0101383 A1
(43) Pub. Date: Apr. 14, 2016

(54) CARBON DIOXIDE CONCENTRATION APPARATUS AND CARBON DIOXIDE SUPPLY METHOD

(71) Applicants: SHIMANE PREFECTURAL GOVERNMENT, Shimane (JP); WASEDA UNIVERSITY, Tokyo (JP); DAIFUKUKOGYO, INC., Shimane (JP)

(72) Inventors: Kazuyuki Omura, Izumo-shi (JP); Kazuhide Nagano, Izumo-shi (JP); Yumi Goishi, Izumo-shi (JP); Masahiro Tajima, Matsue-shi (JP); Yoshinori Nishio, Matsue-shi (JP); Atsushi Yamazaki, Tokyo (JP)

(21) Appl. No.: 14/890,988

(22) PCT Filed: May 14, 2014
(86) PCT No.: PCT/JP2014/062809

§ 371 Date: Nov. 13, 2015

(30) Foreign Application Priority Data
May 16, 2013 (JP) 2013-118291
Dec. 16, 2013 (JP) 2013-258992

(51) Int. Cl. B01D 53/047; A01G 9/18; A01G 1/00

(52) U.S. Cl. CPC B01D 53/047; A01G 1/001; A01G 9/18; B01D 2253/108; B01D 2256/22

(57) ABSTRACT

Enhanced concentration of carbon dioxide, typically of carbon dioxide in the air, is advantageous in areas such as agriculture and horticulture involving raising of plants which utilize carbon dioxide for photosynthesis. Various carbon dioxide concentration apparatus have been developed, but the problems thereof are numerous. It is accordingly the purpose of the present invention to develop an adsorbent having exceptional adsorption of carbon dioxide, and to provide an apparatus for concentration of carbon dioxide in the air through the use thereof. Provided is a pressure swing concentration apparatus that uses ferrierite as the adsorbent, the ferrierite having been subjected to alkali treatment to give a pore diameter of 0.01-1 μm and a pore volume of 0.1 mL/g or above.

### FIELD OF THE INVENTION

The present invention relates to an apparatus for concentrating carbon dioxide and a method of supplying carbon dioxide making use of this apparatus.

### BACKGROUND OF THE INVENTION

Concentrating carbon dioxide, or generally, raising concentration of carbon dioxide in the air is useful for agriculture, horticulture, or the like in which there is grown plants making use of carbon dioxide for photosynthesis. But, the apparatus of the present invention is not limited of use to those referred to above and is applicable to other usage.

Explanation hereunder will be made by referring to such use as that carbon dioxide collected from atmosphere is applied to growing of plants, particularly to horticulture facilities such as greenhouses, factories of plants, or the like. However, the present invention should not be limited to this use, as mentioned above.

As for cultivation products such as strawberries, melon, tomato, or the like, they are raised in the facilities generally as greenhouses in consideration of controlling temperatures. Since the inside of the greenhouses is a closed space, carbon dioxide inside the greenhouses is consumed with photosynthesis at the time of the day when sunlight radiates. As a result, there is caused the problem of lowering concentration of carbon dioxide. To this, it is known to make higher concentration of carbon dioxide at the time of the day when photosynthesis with sunlight is much carried out, so that growth of the plant is facilitated. For this purpose, cultivation using greenhouses sets the concentration of carbon dioxide in the greenhouse to 1000 ppm or more in order to facilitate growth of cultivated products, increase of yield, and improvement of the quality of products.

As for the method of supplying high concentration carbon dioxide into the horticulture facilities, it is hitherto known the method (patent documents 1 and 2) that an exhaust gas generated at a combustion device, which gas contains much carbon dioxide, is made use of for adjusting atmospheric air. For example, in case of supplying carbon dioxide in the day time, a combustion equipment, which performs complete combustion and does not generate carbon monoxide, is used to burn kerosene or LP gas to supply carbon dioxide. Also, there is such method that an exhaust gas from a heater used for heating rooms at the night is partially introduced into greenhouses or plastic sheet greenhouses to raise concentration of carbon dioxide in the greenhouse. But, concentration of carbon dioxide abruptly lowers when photosynthesis begins, and carbon dioxide becomes insufficient in the afternoon. Moreover, in case that an exhaust gas, as from heavy oil, much contains harmful substances, it is needed that the harmful substances such as sulfur oxide, nitrogen oxide, carbon monoxide, or the like are first removed, and thereafter, carbon dioxide is introduced into the greenhouse or plastic sheet greenhouse.

For a method of supplying high concentration carbon dioxide into horticulture facilities, such technology has been developed that carbon dioxide is collected from an exhaust gas burnt for heating at the night and is applied in the daytime (patent document 3). But, since the source of supply of carbon dioxide is a combustion gas generated at the night by the heating equipment, it is a problem that this method of supplying carbon dioxide is usable only in the season of winter.

Further, it has been also developed such method that carbon dioxide in the atmosphere is concentrated in order to supply carbon dioxide irrespective of seasons (patent document 4). There is described that an adsorption device in a pressure swing system is used to concentrate carbon dioxide in the atmosphere, so that carbon dioxide in concentration of 500 through 2000 ppm is supplied into the greenhouse or plastic sheet greenhouse. While, a small greenhouse in 10 m³ or less for experiment would not have any problems, a large-sized greenhouse to be practically used will have the problem that concentration of carbon dioxide does almost not rise unless a large-sized carbon dioxide concentrating device is used to increase supply amount of concentrated carbon dioxide. It is hard to practically use the large-sized carbon dioxide concentrating device due to high cost for its facilities.

### PRIOR ART DOCUMENTS

### Patent Documents

Patent document 1: Japanese unexamined patent application HEI 1-305809
Patent document 2: Japanese unexamined patent application 2009-153459
Patent document 3: Japanese unexamined patent application 2012-16322
Patent document 4: Japanese unexamined patent application HEI 6-253682

### BRIEF DESCRIPTION OF THE INVENTION

### Tasks the Invention is to Solve

The present invention has been designed to overcome the problems under the circumstances. An adsorbent material superior in adsorbing carbon dioxide is developed. And a compact concentrating device using the adsorbent material for concentrating carbon dioxide in the air is developed, so that supplying of concentrated carbon dioxide is realized without relying upon the combustion system.

### Means for Solving the Tasks

Under the circumstances, the inventors have achieved the concentrating apparatus for carbon dioxide and the method of supplying carbon dioxide using the concentrating apparatus according to the present invention. The concentrating apparatus is characterized in a concentrating apparatus of pressure swing system using ferrierite as adsorbent, ferrierite subjected to alkaline treatment to have pores in diameter of 0.01 through 1 μm and pore volume of 0.1 mL/g or more. And the method of supplying carbon dioxide is characterized in that carbon dioxide concentrated with the apparatus set forth in claim 1 is supplied for growing plants.

Ferrierite is a kind of zeolite and has the structure code FER in the International Zeolite Association. Ferrierite may be natural or synthetic, and may be preferable to be particle-shaped or cylindrical in diameter of 0.5 mm through 5 mm, more preferably 0.5 mm through 2 mm, to be filled in the adsorber or adsorption tower of the pressure swing type concentrating apparatus. If the size of ferrierite is 0.5 mm or less, pressure loss at the adsorption tower is too high and operation efficiency of air pump is poor.

If the size of ferrierite is 5 mm or more, gas inside the particles slowly disperses, resulting in that the inside of the particles are not made use of.

Furthermore, the ferrierite adsorbent when measured with mercurial press fit-type pore distribution measuring equipment has 0.1 mL/g or more of pore volume in the range of pore diameter from 0.01 μm to 1 μm. Natural ferrierite is mined in the form of a hard rock and therefore its structure is fine and has a little the pores in diameter of 0.01 μm or more. Meanwhile, to make higher the rate of adsorbing and desorbing gases, it is preferable there are many pores in diameter of 0.01 μm or more. Particularly, in case that particle diameter is 0.5 mm or more, when a dispersion rate inside the particles is low, the inside of the particles are not used for the adsorbing operation, resulting in less amount of adsorption. Hence, it is significant that pores in diameter of 0.01 μm or more are increased in number to make higher the dispersion rate inside the particles and thereby enable also the inside of the particles to be made use of for the adsorbing operation. To be noted is that when pores in diameter of 0.01 μm or more are too many, strength of the adsorbent particles lowers, resulting in that the pressure swing type adsorbing apparatus will be hard to operate due to that broken pieces of adsorbent material are clogged up in the adsorption tower and pressure loss becomes higher.

In order to provide ferrierite with more pores in diameter of 0.01 μm or more, it is effective to treat ferrierite particles with an alkaline solution to cause silica components to be dissolved partially. Alkaline solution may employ aqueous solution of: sodium hydroxide, potassium hydroxide, sodium carbonate, or potassium carbonate, sodium hydroxide being most preferable in respect of alkalinity and price. Concentration of sodium hydroxide may be preferably 1.5 mol/L or more.

The adsorbent material to be filled in the adsorption column may be not entirely the above-mentioned ferrierite. In other words, the adsorbent material which is subjected to addition of mordenite or other zeolite or is replaced partially with these substances may be usable. It is natural that the adsorbent material should contain as a whole the above-mentioned ferrierite in weight ratio of 50% or more.

Pressure swing type concentrating apparatus which is known to public is able to make concentrating sequentially by using alternately at least two adsorption towers. For the present invention, the pressure swing type concentrating apparatus does not need to be a special one but may employ a general one.

In brief, the adsorbent material is filled in two adsorption towers to which air containing carbon dioxide is supplied, so that high pressure adsorption process and low pressure collection process are alternately repeated in the respective adsorption towers, thereby generating carbon dioxide concentrated air.

In the present invention, by use of ferrierite adsorbent material having increased pores, and by adopting, for example, adsorbing, pressure equalizing, flow-back, and re-generating processes as the operation cycle for the carbon dioxide concentrating apparatus, a predetermined carbon dioxide concentrated gas in the range of 3000 through 15000 ppm can be taken out effectively. Adsorption pressure in the adsorption process of the present invention is generally 2.0 through 9.9 kgf/cm²G, preferably 2 through 5 kgf/cm²G, most preferably 2 through 3 kgf/cm²G. Also, re-generation pressure in the collection process is generally 1 kPa or less, or 0.5 kPa or less, most preferably 0.2 kPa or less.

The effect of concentrated carbon dioxide in the present invention is well shown with concentration of condensed carbon dioxide in the range of 500 ppm through 15000 ppm, preferably 1000 ppm through 15000 ppm, most preferably 3000 ppm through 15000 ppm. When the carbon dioxide concentration is over 15000 ppm, efficiency of required power and gas yield or the like of the pressure swing type carbon dioxide concentrating apparatus (called hereunder PSA apparatus) do lower, and economical efficiency lowers. Furthermore, in case that carbon dioxide concentration is less than 500 ppm, significance and effect of the concentrating is less generally.

Use of supplying, in other words, making use of carbon dioxide concentrated by the apparatus of the present invention may be for agriculture.

In detail, the use may be, for example, introducing of concentrated carbon dioxide into greenhouses or vinyl houses for growing plants, or into a closed space (for increasing concentration of carbon dioxide) irrespective of temperatures, and moreover, supplying of concentrated carbon dioxide to plants at a site not tightly sealed, or the like.

More specifically exemplifying, condensed carbon dioxide of the present invention may be usable for growing bean sprouts, daikon radish sprouts or the like, or for growing in the greenhouses or the like tomato, green bell pepper, strawberry, melon, cucumber, asparagus, or the like. High concentration carbon dioxide manufactured by the carbon dioxide concentrating apparatus is supplied usually through a gas flow control valve. In this case, carbon dioxide may be preferably supplied, with tubes, to parts of leaves of plants bodies. In case that carbon dioxide is concentrated from the atmosphere, since the quantity of manufacture of high concentration carbon dioxide containing gas is low, it is hard to increase the concentration of carbon dioxide entirely of the plants-growing rooms. Thus, it is preferable to supply carbon dioxide by use of tubes locally to the parts of leaves where photosynthesis is performed and carbon dioxide is required. It will be appreciated that the supply amount of high concentration carbon dioxide may be increased to be introduced entirely of plants.

### Effects of the Invention

The carbon dioxide concentrating apparatus of the present invention employs for the adsorbent material ferrierite having increased number of pores, thereby enabling that carbon dioxide of high concentration is supplied directly to various facilities. A particularly large effect is shown for agriculture. For example, sugar content of strawberry has been largely improved.

### BRIEF DESCRIPTION OF THE DRAWINGS

FIG. 1: A schematic explanatory view showing an example of a carbon dioxide concentrating apparatus according to the present invention.

### EMBODIMENTS TO USE THE INVENTION

Hereunder, preferable embodiments of the present invention will be detailed. To be noted is that the embodiments shown hereunder should be solely an example. The present invention should not at all be limited to the embodiments.

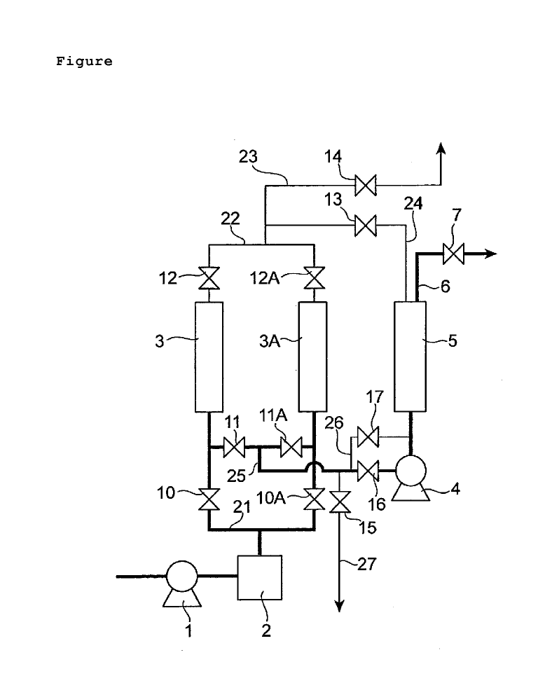

FIG. 1 is a schematic explanatory view showing an example of a carbon dioxide concentrating apparatus according to the present invention. A feed air is pressurized by a blower 1 to flow through an air drier 2, an inflow passage pipe 21, and an on-off valve 10 (or 10A), to be supplied to an adsorber or adsorption tower 3 (or 3A).

Explanation will be made here for the case that adsorption is carried out at the adsorption tower 3. After the pressurized air is supplied to the adsorption tower 3, carbon dioxide is adsorbed by adsorbent materials placed in the adsorption tower 3, and other gases pass through an on-off valve 12, exhaust passage pipe 22, 23 and an on-off valve 14 to be discharged out of the system. Time required for the adsorption process is 300 through 900 seconds, preferably 300 through 600 seconds. Before the adsorbent material is saturated, the adsorption process ends, and the on-off valves, 10, 12, 14 are closed. In this case, it is preferable to insert a pressure equalizing process following the adsorption process. The pressure equalizing process is so performed that the on-off valves 11 or 11A, and 15 are opened, and the line 25, 27 are used to discharge high pressure air from the adsorption column 3. After the pressure equalizing process ends, the collection process is carried out. Time required for the collection process is 300 through 900 seconds, preferably 300 through 600 seconds, similarly to that required for the adsorption process. The collection process is so performed that the on-off valves 11, 16 are opened, and, the adsorption tower 3 is depressurized by use of a vacuum pump 4, so that carbon dioxide adsorbed by the adsorbent materials in the adsorption column 3 is subjected to desorption and collected to be fed into a reservoir tank 5. The product carbon dioxide concentrated gas in the reservoir tank 5 is taken out by use of a gas flow control valve 7 through a supplying pipe 6 of carbon dioxide concentrated gas.

In this example, after the adsorption process ends, a purge process may be applied before or after the pressure equalizing process. The purge process causes the product carbon dioxide concentrated gas in the reservoir tank 5 to flow from the bottom of the adsorption tower 3 to its top (or to flow from the top to the bottom of the adsorption tower 3) and be discharged to the outside of the adsorption tower 3. For example, it may be so adapted that the on-off valves 11, 12, 14, 17 are opened, collected carbon dioxide concentrated gas in the reservoir tank 5 is caused to flow from a return line 26 to the adsorption tower 3, the on-off valve 14 is opened, thereby discharging the collected carbon dioxide concentrated gas to the outside of the system. Otherwise, it may be so adapted that the on-off valves 11, 17, 12, 12A are opened to allow the collected carbon dioxide concentrated gas to be supplied to the adsorption tower 3A. By this, purity of collected carbon dioxide concentrated gas is able to be improved.

Furthermore, in place of or following the purge process, a flow-back process may be added. The flow-back process causes collected carbon dioxide concentrated gas in the reservoir tank 5 to flow from the top to the bottom of the adsorption tower 3 through the line 24 and valve 13, so that while adsorbed carbon dioxide is subjected to desorption, the product carbon dioxide concentrated gas is collected again into the reservoir tank 5 through the on-off valves 11, 16 and vacuum pump 4.

### Adsorbent Material's Example 1

### Alkaline Treatment of Ferrierite

Natural ferrierite obtained in Shimane Prefecture was subjected to particle size regulation in size of 2 through 5 mm. The particles 10 g were placed in 100 g of pure water, to which 0.15 mol of sodium hydroxide was added. The pure water was subjected to shaking overnight at a room temperature. The natural ferrierite was rinsed with pure water, and then dried at 120° C. The natural ferrierite treated with alkali was measured of pores dispersion by use of mercury press-fit type pore dispersion measuring device (Quantachrome Corporation). As a result, pore volume with pore diameter in the range of 0.01 through 1.0 μm was 0.1056 mL/g.

### Adsorbent Material's Example 2

The same treatment as adsorbent material's example 1 was carried out except that addition of sodium hydroxide was 0.225 mol. As a result, pore volume with pore diameter in the range of 0.01 through 1.0 μm was 0.1086 mL/g.

### Adsorbent Material's Example 3

The same treatment as adsorbent material's example 1 was carried out except that in place of sodium hydroxide, potassium hydroxide 0.15 mol was added. As a result, pore volume with pore diameter in the range of 0.01 through 1.0 μm was 0.1042 mL/g.

### Adsorbent Material's Example 4

The same treatment as adsorbent material's example 1 was carried out except that in place of sodium hydroxide, potassium hydroxide 0.225 mol was added. As a result, pore volume with pore diameter in the range of 0.01 through 1.0 μm was 0.1055 mL/g.

### Comparative Adsorbent Material 1

Natural ferrierite subjected to no treatment was measured regarding pore volume with pore diameter in the range of 0.01 through 1.0 μm, measurement result being 0.0654 mL/g.

### Comparative Adsorbent Material 2

The same treatment as adsorbent material's example 1 was carried out except that addition of sodium hydroxide was 0.075 mol. As a result, pore volume with pore diameter in the range of 0.01 through 1.0 μm was 0.0831 mL/g.

### Comparative Adsorbent Material 3

The same treatment as adsorbent material's example 1 was carried out except that in place of sodium hydroxide, sodium carbonate 0.225 mol was added. As a result, pore volume with pore diameter in the range of 0.01 through 1.0 μm was 0.0892 mL/g.

### EXAMPLE 1

A carbon dioxide adsorption apparatus the same as that shown in FIG. 1 was made, and 1 L of ferrierite referred to in the adsorbent material's example 1 was filled in the adsorption tower. Operation with adsorption pressure 2 kgf/cm²G, desorption pressure 300 Pa, and adsorption and desorption cycle 10 min, was performed, and also a purge process from the reservoir tank to the adsorption tower was carried out. Concentration of carbon dioxide at the supply port of carbon dioxide was about 10,000 ppm. In this case, rate of concentrating carbon dioxide was about 27 times the concentration of carbon dioxide in the atmosphere.

### EXAMPLE 2

The same operation as EXAMPLE 1 was carried out except that 1 L of ferrierite of the adsorbent material's example 2 was filled in the adsorption tower. Concentration of carbon dioxide at the supply port of carbon dioxide was about 9,500 ppm. In this case, rate of concentrating carbon dioxide was about 25.7 times the concentration of carbon dioxide in the atmosphere.

### EXAMPLE 3

The same operation as EXAMPLE 1 was carried out except that 1 L of ferrierite of the adsorbent material's example 3 was filled in the adsorption tower. Concentration of carbon dioxide at the supply port of carbon dioxide was about 9,800 ppm. In this case, rate of concentrating carbon dioxide was about 26.5 times the concentration of carbon dioxide in the atmosphere.

### EXAMPLE 4

The same operation as EXAMPLE 1 was carried out except that 1 L of ferrierite of the adsorbent material's example 4 was filled in the adsorption tower. Concentration of carbon dioxide at the supply port of carbon dioxide was about 9,500 ppm. In this case, rate of concentrating carbon dioxide was about 25.7 times the concentration of carbon dioxide in the atmosphere.

### COMPARATIVE EXAMPLE 1

The same operation as EXAMPLE 1 was carried out except that 1 L of non-treated natural ferrierite (the comparative adsorbent material 1) was filled in the adsorption tower. Concentration of carbon dioxide at the supply port of carbon dioxide was about 4,000 ppm. In this case, rate of concentrating carbon dioxide was about 10.8 times the concentration of carbon dioxide in the atmosphere.

### COMPARATIVE EXAMPLE 2

The same operation as EXAMPLE 1 was carried out except that 1 L of the comparative adsorbent material 2 was filled in the adsorption tower. Concentration of carbon dioxide at the supply port of carbon dioxide was about 5,000 ppm. In this case, rate of concentrating carbon dioxide was about 13.5 times the concentration of carbon dioxide in the atmosphere.

### COMPARATIVE EXAMPLE 3

The same operation as EXAMPLE 1 was carried out except that 1 L of the comparative adsorbent material 3 was filled in the adsorption tower. Concentration of carbon dioxide at the supply port of carbon dioxide was about 6,800 ppm. In this case, rate of concentrating carbon dioxide was about 18.3 times the concentration of carbon dioxide in the atmosphere.

### EXAMPLE 5

The same operation as EXAMPLE 1 was carried out except that 0.5 L of ferrierite of the adsorbent material's example 1 and 0.5 L of natural mordenite were filled. Concentration of carbon dioxide at the supply port of carbon dioxide was about 8,000 ppm. In this case, rate of concentrating carbon dioxide was about 21.6 times the concentration of carbon dioxide in the atmosphere.

### COMPARATIVE EXAMPLE 4

The same operation as EXAMPLE 1 was carried out except that 0.3 L of ferrierite of the adsorbent material's example 1 and 0.7 L of natural mordenite were filled. Concentration of carbon dioxide at the supply port of carbon dioxide was about 6,200 ppm. In this case, rate of concentrating carbon dioxide was about 16.8 times the concentration of carbon dioxide in the atmosphere.

### COMPARATIVE EXAMPLE 5

The same operation as EXAMPLE 1 was carried out except that 0.4 L of ferrierite of the adsorbent material's example 1 and 0.6 L of natural mordenite were filled. Concentration of carbon dioxide at the supply port of carbon dioxide was about 7,000 ppm. In this case, rate of concentrating carbon dioxide was about 18.9 times the concentration of carbon dioxide in the atmosphere.

### EXAMPLE 6

### Test of Growing Plants Bodies

With the adsorbent material and operation referred to in the EXAMPLE 1, carbon dioxide of concentration 10000 ppm was supplied, through tubes, to leaves part of strawberry seedlings from 8:00 to 17:00 hours to grow strawberry. Carbon dioxide around leaves was 2,000 ppm. Growing was continued from November to March with carbon dioxide being kept supplied. Sugar content of grown strawberry fruit was 10.2% in our measurement result.

### COMPARATIVE EXAMPLE 6

Regarding strawberry grown without supplying carbon dioxide, measurement result of sugar content of strawberry fruit was 8.1%.

### EXAMPLE 7

### Test of Growing of Plants Bodies

Test of growing strawberry was carried out from October to April with carbon dioxide of concentration 10000 ppm being supplied, by use of tubes, to the part of leaves of 60 bushes of strawberry seedlings from 8:00 to 17:00 hours using the adsorbent material and operation referred to in the EXAMPLE 1. A first blossoming was seen on the 42nd day from planting. Also, a total crop of strawberry was 13.57 kg.

### COMPARATIVE EXAMPLE 7

The same test of growing strawberry as EXAMPLE 7 was carried out except that carbon dioxide was not supplied. The first blossoming was on the 57^{th} day from planting which is fifteen days slower in comparison with the feature of carbon dioxide being supplied. Also, the total crop of strawberry was 10.15 kg which is 35% less than the feature of carbon dioxide being supplied.

As seen from the above, it has been confirmed from EXAMPLES 6, 7 and COMPARATIVE EXAMPLES 6, 7 that carbon dioxide is supplied by use of the carbon dioxide supplying apparatus according to the present invention, so that growing of strawberry is facilitated, sugar content is improved, the crop is increased, and the effect in growing plants in the greenhouses or plastic sheet greenhouses is high.

### EXPLANATION OF REFERENCE NUMERALS

1: Blower
2: Air drier
3, 3A: Adsorber or adsorption tower
4: Vacuum pump
5: Reservoir tank
6: Pipe for supplying carbon dioxide concentrated gas
7: Gas flow control valve
10, 10A, 11, 11A, 12, 12A: On-off valve
13, 14, 15, 16, 17: On-off valve
21: Inflow passage pipe
22: Exhaust passage pipe
23: Exhaust passage pipe
24, 25: Line
26: Return line
27: Line

What we claimed:

1. A carbon dioxide concentrating apparatus comprising a pressure swing type concentrating device using ferrierite as an adsorbent material, characterized in that said ferrierite is subjected to alkaline treatment to have pores in diameter of 0.01 through 1 μm and pore volume of 0.1 mL/g or more.

2. A carbon dioxide concentrating apparatus as set forth in claim 1 wherein carbon dioxide in the atmosphere is concentrated 20 times or more.

3. A method of supplying carbon dioxide which supplies, for growing plants, carbon dioxide concentrated by the apparatus as set forth in claim 1.
